(19) United States
(12) Patent Application Publication
(10) Pub. No.: US 2025/0138850 A1
(43) Pub. Date: May 1, 2025

(54) METHOD AND SYSTEM FOR IMPLEMENTING TASK ASSISTANT

(71) Applicant: SAMSUNG SDS CO., LTD., Seoul (KR)

(72) Inventors: Yeong Dae KWON, Seoul (KR); Jin Ho CHOO, Seoul (KR); Ji Hoon KIM, Seoul (KR)

(73) Assignee: SAMSUNG SDS CO., LTD., Seoul (KR)

(21) Appl. No.: 18/929,201

(22) Filed: Oct. 28, 2024

(30) Foreign Application Priority Data
Oct. 31, 2023 (KR) 10-2023-0148446
Feb. 14, 2024 (KR) 10-2024-0020866

(51) Int. Cl. G06F 9/451; G10L 15/22

(52) U.S. Cl. CPC G06F 9/451; G10L 15/22

(57) ABSTRACT

A method and a system for implementing a task assistant are provided. The method according to some embodiments may include receiving a user's command including a task description regarding a target task, generating a screen description by analyzing a screen of a task execution device, configuring a first prompt for determining a first action associated with the target task based on the task description and the screen description, determining the first action by inputting the first prompt to a generative model and executing the first action through the task execution device.

### CROSS-REFERENCE TO RELATED APPLICATION(S)

This application claims priority from Korean Patent Application No. 10-2023-0148446 filed on Oct. 31, 2023, and Korean Patent Application No. 10-2024-0020866 filed on Feb. 14, 2024, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and a system for implementing a task assistant.

### 2. Description of the Related Art

Representative examples of technologies that execute tasks of a user on a computer include robotic process automation (RPA). The RPA is a technology that executes a task of a user through a series of actions that are defined in advance, and has been currently utilized in various fields.

However, in order to execute a specific task using the RPA technology, details and the order of actions required for processing (solving) the specific task should be precisely defined in advance. That is, the RPA technology has a clear limitation in that it may not process a task of a user that is not defined in advance.

### SUMMARY

Aspects of the present disclosure provide a method and a system for accurately implementing a task assistant.

Specifically, aspects of the present disclosure provide a method and a system for accurately determining an action list required for processing (solving) a task of a user. For example, aspects of the present disclosure provide a method and a system for accurately determining actions required for processing (solving) a task of a user that is not defined in advance and the order of the actions.

Aspects of the present disclosure also provide a method for configuring a prompt capable of inducing an accurate response from a generative model.

Aspects of the present disclosure also provide a method for effectively generating a demo example for a specific task.

Aspects of the present disclosure also provide an effective utilization example for a task assistant.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of the present disclosure, there is provided a method for implementing a task assistant, executed by at least one processor, the method include: receiving a user's command including a task description regarding a target task; generating a screen description by analyzing a screen of a task execution device, configuring a first prompt for determining a first action associated with the target task based on the task description and the screen description, determining the first action by inputting the first prompt to a generative model and executing the first action through the task execution device.

In some embodiments, the generating of the screen description includes identifying one or more components existing on the screen and assigning an identifier to each of the one or more components, the screen description including information on the identifier.

In some embodiments, the first prompt includes an instruction for requesting the generative model to output a first context associated with the first action, and the first context is a set of information that the generative model considers to determine the first action.

In some embodiments, the first context includes at least one of information of the target task understood by the generative model and information of the screen understood by the generative model.

In some embodiments, the first context includes a reason why the generative model has determined the first action.

In some embodiments, the first context includes plan information on an action to be executed after the first action.

In some embodiments, the method may further include configuring a second prompt for determining a second action associated with the target task based on the first context, the second action being a subsequent action of the first action and determining the second action by inputting the second prompt to the generative model.

In some embodiments, the second prompt is configured further based on the task description and a screen description for the screen updated by the first action.

In some embodiments, the first prompt includes a list of actions executed before the first action.

In some embodiments, the configuring of the first prompt includes obtaining a successful demo example associated with the target task by searching a demo database (DB) and adding the successful demo example to the first prompt.

In some embodiments, each of a plurality of successful demo examples is stored in the demo DB in a state in which it is matched to a task embedding, and the obtaining of the successful demo example includes generating an embedding of the target task by embedding the task description and searching the demo DB based on similarity between the embedding of the target task and the task embedding.

In some embodiments, a process of constructing the demo DB includes obtaining an action list and a context list associated with a specific task, the context list including a context associated with an action included in the action list, and the context being a set of information that the generative model considers to determine the action, generating a summary context list from the action list and the context list through a specific generative model and storing a demo example of the specific task including the action list and the summary context list in the demo DB.

In some embodiments, a process of constructing the demo DB includes obtaining a task execution record of a specific user for a specific task, the task execution record including a first action list associated with the specific task and a screen image, extracting information on a component existing in the screen image by analyzing the screen image, converting the first action list into a second action list regarding the component with reference to the extracted information and storing a demo example of the specific task including the second action list in the demo DB.

In some embodiments, a process of constructing the demo DB includes obtaining an action list associated with a specific task, generating any one of a context list and a summary context list of the action list from a description of the specific task and the action list through a specific generative model, a context included in the context list being a set of information that the generative model considers to determine an action included in the action list and storing a demo example of the specific task including the generated list and the action list in the demo DB.

In some embodiments, the configuring of the first prompt includes obtaining an unsuccessful demo example associated with the target task by searching a demo DB and adding the unsuccessful demo example to the first prompt.

In some embodiments, a process of constructing the demo DB includes obtaining an action list determined through the generative model before at a point in time when an execution interruption command for a specific task is received when the execution interruption command is received from a specific user, generating the unsuccessful demo example based on the action list and storing the unsuccessful demo example of the specific task in the demo DB.

In some embodiments, a process of constructing the demo DB includes obtaining a first action list executed before at a point in time when an execution interruption command for a specific task is received when the execution interruption command is received from a specific user, obtaining a second action list from a task execution record of the specific user for the specific task, the task execution record being an execution record for an unexecuted portion of the specific task, generating a successful demo example based on the first action list and the second action list and storing the successful demo example of the specific task in the demo DB.

In some embodiments, the executing of the first action includes converting the first action into a manipulation message for an input device of the task execution device and transmitting the manipulation message to the task execution device.

According to some embodiments of the present disclosure, there is provided a system, the system comprising a screen analyzer generating a screen description by analyzing a screen of a task execution device, an action determining module receiving a user's command including a task description regarding a target task, configuring a first prompt for determining a first action associated with the target task based on the screen description and the task description, and determining the first action by inputting the first prompt to a generative model and an action executing module executing the first action through the task execution device.

In some embodiments, the screen analyzer generates the screen description by identifying one or more components existing on the screen and assigning an identifier to each of the one or more components.

In some embodiments, the first prompt includes an instruction for requesting the generative model to output a first context associated with the first action, and the first context is a set of information that the generative model considers to determine the first action.

In some embodiments, the first prompt includes a list of actions executed before the first action.

In some embodiments, the action determining module obtains a successful demo example associated with the target task by searching a demo DB, and configures the first prompt further based on the successful demo example.

In some embodiments, the action determining module obtains an unsuccessful demo example associated with the target task by searching the demo DB, and configures the first prompt further based on the unsuccessful demo example.

In some embodiments, the action executing module executes the first action by converting the first action into a manipulation message for an input device of the task execution device and transmitting the manipulation message to the task execution device.

According to some embodiments of the present disclosure, there is provided a non-transitory computer-readable storage medium storing instructions, when the instructions are executed by one or more processors, the instructions cause the one or more processors to execute an operation of receiving a user's command including a task description regarding a target task, an operation of generating a screen description by analyzing a screen of a task execution device, an operation of configuring a first prompt for determining a first action associated with the target task based on the task description and the screen description, an operation of determining the first action by inputting the first prompt to a generative model and an operation of executing the first action through the task execution device.

According to some exemplary embodiments of the present disclosure, an action for a target task may be repeatedly determined using a generative model that may understand a user's command, and the target task may be processed by executing the determined action. In such a case, unlike a robotic process automation (RPA) technology according to the related art, various tasks that are not defined in advance may be accurately processed. Moreover, complicated tasks executed through various applications on a computing device may be easily automated. Furthermore, a user does not need to directly manipulate the computing device, and thus, manipulation convenience of the computing device may be greatly improved.

In addition, by including an instruction for requesting the generative model to output a context in a prompt for action determination, the generative model may be induced to more accurately determine the action of the target task.

In addition, by including a context history in a prompt for determining the next action again, consistency and accuracy of an action determination logic of the generative model may be further improved.

In addition, by including an unsuccessful demo example and/or a successful demo example related to the target task in the prompt, action determination accuracy of the generative model may be further improved. That is, the unsuccessful demo example and/or the successful demo example serve as reference (guide) information when the action is determined, and thus, the action determination accuracy of the generative model may be further improved.

In addition, a summary context list corresponding to a context list may be generated through the generative model, and a demo example may be generated based on the summary context list. In such a case, information efficiency of the demo example and space efficiency of a demo database (DB) may be simultaneously improved.

In addition, various demo examples may be easily generated based on a task execution record of the user. Furthermore, by accumulating demo examples of a specific user in the demo DB, a customized task assistant (i.e., a personalized task assistant) for the specific user may be easily implemented.

In addition, by accumulating demo examples of an expert (i.e., a skilled user) in the demo DB, a task assistant (or a task assistant system/device) that may educate (guide) an unskilled user on a task execution method may be easily implemented. In addition, task knowledge of the expert may be easily and accurately transferred to various unskilled users through such a task assistant (or a task assistant system/device).

The effects according to the technical spirit of the present disclosure are not limited to the aforementioned effects, and various other effects may be obviously understood by one of ordinary skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an illustrative diagram for describing an operation environment of a task assistant according to some exemplary embodiments of the present disclosure;

FIG. 2 is an illustrative diagram for describing an operation of the task assistant according to some exemplary embodiments of the present disclosure in detail;

FIG. 3 is a diagram illustrating an example of a task that may be referenced in various exemplary embodiments of the present disclosure and a task execution process;

FIG. 4 is an illustrative block diagram illustrating a system for implementing a task assistant according to some exemplary embodiments of the present disclosure;

FIG. 5 is an illustrative diagram for describing an operation of a screen analyzer according to some exemplary embodiments of the present disclosure;

FIG. 6 is an illustrative block diagram for describing a configuration and an operation of an action determining module according to some exemplary embodiments of the present disclosure;

FIG. 7 is an illustrative diagram for describing an operation of a demo example searcher according to some exemplary embodiments of the present disclosure;

FIG. 8 is an illustrative diagram for describing elements constituting a prompt according to some exemplary embodiments of the present disclosure;

FIGS. 9 to 11 are illustrative diagrams for describing a method for generating a demo example according to some exemplary embodiments of the present disclosure;

FIGS. 12 to 14 are illustrative diagrams for describing a method for generating a demo example according to some other exemplary embodiments of the present disclosure;

FIG. 15 is an illustrative block diagram illustrating a system for implementing a task assistant according to some other exemplary embodiments of the present disclosure;

FIG. 16 is an illustrative diagram for describing a method for generating a demo example according to some other exemplary embodiments of the present disclosure;

FIG. 17 is an illustrative flowchart illustrating portions of a method for implementing a task assistant according to some exemplary embodiments of the present disclosure;

FIG. 18 is an illustrative diagram for describing determining a first action illustrated in FIG. 17 in detail;

FIG. 19 is an illustrative flowchart illustrating the other portions of the method for implementing a task assistant according to some exemplary embodiments of the present disclosure;

FIG. 20 is an illustrative diagram for describing determining a second action illustrated in FIG. 19 in detail;

FIGS. 21 and 22 are illustrative diagrams for describing a utilization example of a task assistant system according to some exemplary embodiments of the present disclosure; and

FIG. 23 is an illustrative hardware configuration diagram illustrating a computing device/system according to some other exemplary embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms.

Components described with reference to the terms “unit”, “module”, “block”, “˜or/er”, and the like, as used herein or functional blocks as illustrated in the drawings may be implemented in the form of software, hardware, or a combination thereof. The software may be, for example, a machine code, firmware, an embedded code, and application software. In addition, the hardware may include, for example, an electric circuit, an electronic circuit, a processor, a computer, an integrated circuit, integrated circuit cores, a passive component, or a combination thereof.

Before describing various exemplary embodiments of the present disclosure, the terms as used herein will be clarified.

A task as used herein refers to any task or job executable on a computing device/system. Examples of the task may include “viewing e-mails received from a user A for a predetermined period”, “viewing e-mails related to a specific task,” “executing a specific application,” and the like, but the scope of the present disclosure is not limited thereto. For another example of the task, reference is made to FIG. 3. The task may be processed (solved) by executing a series of actions on the computing device/system.

An action list as used herein refers to a set of actions (or a series of actions) required for processing (solving) a task. The action list may be configured to include one or more actions. In some cases, the action list may also be referred to as an ‘action sequence’ or an ‘action set’.

An action as used herein refers to an execution unit of a task corresponding to a manipulation of the computing device (e.g., a manipulation for an input device). For example, the action may refer to a minimum execution unit of a task corresponding to a keyboard or mouse manipulation. Here, the mouse action/manipulation includes an action/manipulation by touch input. Specific examples of the action may include ‘mouse click at coordinates (X1, Y1)’, ‘mouse scroll by a length L’, ‘mouse scroll to coordinates (X2, Y2)’, ‘Ctrl+C keyboard input’, ‘string “Hello” keyboard input’, and the like, but the scope of the present disclosure is not limited thereto.

A manipulation message as used herein is a message causing an action to be executed through a manipulation of the computing device (e.g., the input device), and is a message converted into a form in which the computing device may execute the action. For example, the manipulation message may be generated by converting keyboard and mouse-related actions into a form in which the computing device may receive and execute the actions. As a more specific example, an action of ‘clicking No. 1 button on a screen’ (here, No. 1 button is a component positioned at the coordinates (X1, Y1)) may be converted into a manipulation message such as ‘clicking the coordinates (X1, Y1)’.

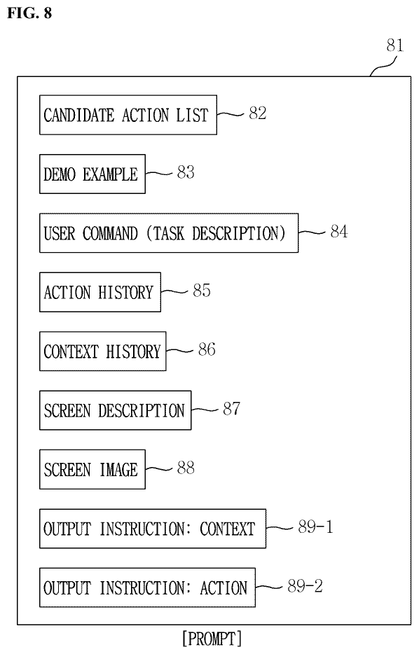

A context as used herein refers to a set of information that a generative model considers in order to determine an action. For example, the context may include task information, screen information, and the like, considered in order to determine an action of a specific task, but is not limited thereto. For detailed information on the context, reference is made to a description of FIG. 8 and Table 2.

A generative model as used herein is a language model that has natural language (text) understanding and generation capabilities. In some cases, the generative model may be a vision language model (or a multi-modal language model) that further has an image understanding capability or may further have an understanding capability for other modalities. The generative model may be a model developed autonomously or a model provided externally. In some cases, the generative model may also be referred to as a ‘language model (LM)’, a ‘large language model (LLM)’, a ‘generative language/deep learning model’, a ‘generative artificial intelligence (AI) model’, or the like.

Hereinafter, various exemplary embodiments of the present disclosure will be described in detail with reference to the accompanying drawings.

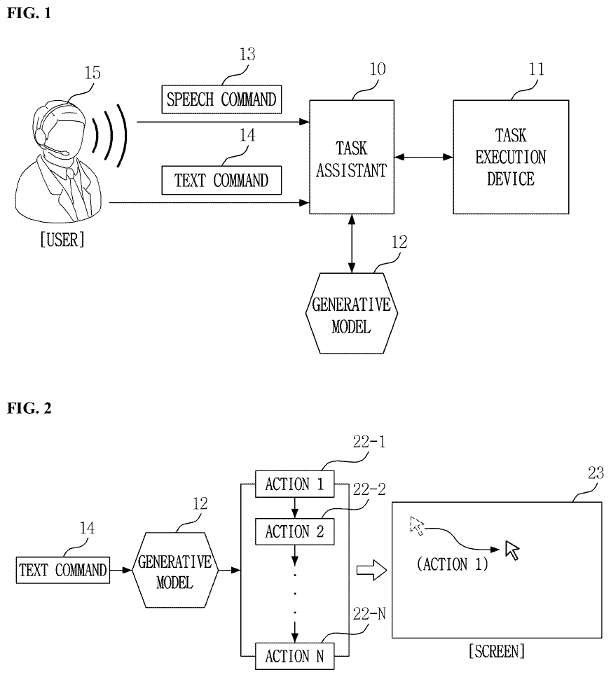

FIG. 1 is a schematic illustrative diagram for describing an operation environment of a task assistant 10 according to some exemplary embodiments of the present disclosure.

As illustrated in FIG. 1, the task assistant 10 may operate in association with a task execution device 11 in order to process (solve) a task (i.e., a target task) of a user 15. For example, the task assistant 10 may receive commands 13 and 14 of the user 15 that include a task description for the target task and execute the target task through the task execution device 11 in response to the commands 13 and 14. The task assistant 10 may also be referred to as a ‘task agent’ in some cases. In addition, the task execution device 11 may also be referred to as a ‘task execution system 11’ in some cases.

It has been illustrated in FIG. 1 that the task assistant 10 is a separate module/device from the task execution device 11, but this is only for providing convenience of understanding, and the task assistant 10 may be mounted and operated in the task execution device 11 (e.g., when all functions of the task assistant 10 are implemented in the task execution device 11 in the form of an application). Alternatively, some functions of the task assistant 10 may be implemented in the task execution device 11 and the other functions of the task assistant 10 may be implemented in another computing device (e.g., a server, etc.). In some cases, the task assistant 10 implemented in another computing device may execute the target task of the user 15 on the task execution device 11. In the following description, a computing device/system implementing at least some functions of the task assistant 10 will be referred to as a ‘task assistant device/system’.

As illustrated in FIG. 1, the task assistant 10 may receive a speech command 13 and/or a text command 14 from the user 15. That is, a user command may be in a speech form or a text form. When the speech command 13 is received, the task assistant 10 may convert the speech command 13 into a text command using a speech-to-text (STT) module and execute the target task requested by the user 15 based on the text command.

As described above, the user command (e.g., 14) may include the task description for the target task. In some cases, the user command (e.g., 14) may further include information (e.g., constraints) such as a condition (e.g., a start condition, an end condition, etc.) related to the target task and an execution manner of the target task. For example, the user command (e.g., 14) may further include conditions regarding an execution (start) point in time, an execution interval, the number of times of execution, an end point in time, and the like, of the target task.

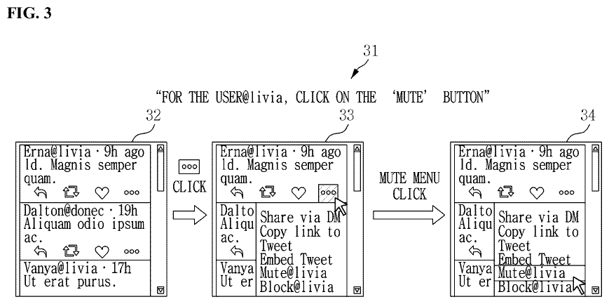

As illustrated in FIG. 1, the task assistant 10 may understand the command (e.g., 14) of the user 15 using a generative model 12 and execute the target task based on understood contents. Specifically, as illustrated in FIG. 2, the task assistant 10 may derive an action list 22-1 to 22-N (here, N is a natural number of 1 or more) required for processing (solving) the target task by understanding the text command 14 of the user through the generative model 12. In addition, the task assistant 10 may process the target task by executing each action (e.g., 21) constituting the action list 22-1 to 22-N through the task execution device 11 (see a screen 23 of the task execution device 11).

For an example of the target task and a process in which the target task is executed (processed) according to the action list derived through the generative model 12, reference is made to FIG. 3 (see 31 to 34).

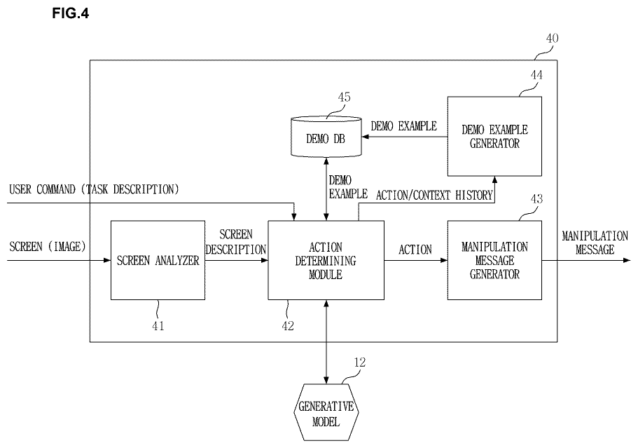

A system/device/method capable of implementing the above-described task assistant 10 will be described in detail later with reference to FIG. 4 and the drawings after FIG. 4.

A description will be provided with reference to FIG. 1 again.

The task execution device 11 is a computing device/system that executes the task (i.e., the target task) according to the command (e.g., 14) of the user 15. The task execution device 11 may be a fixed device or a mobile device (e.g., a mobile terminal such as a smartphone). The task execution device 11 may also refer to a terminal/device/system on a user 15 side. In addition, the task execution device 11 may be the same device/system as or a different device/system from a task assistant system/device 40 (see FIG. 4).

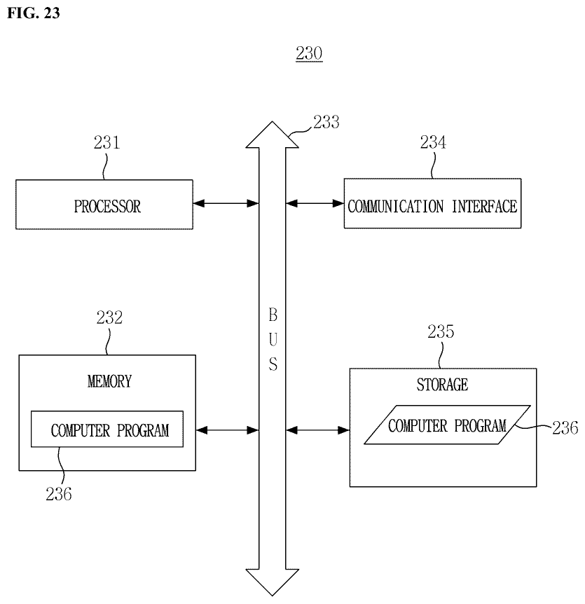

The computing device may include any device having a computing (processing) function, and for an example of such a device, reference is made to FIG. 23. The computing device is an aggregate of various components (e.g., a memory, a processor, etc.) interacting with each other, and may thus be referred to as a ‘computing system’ in some cases. The term “computing system” may also encompass the concept of an aggregate of a plurality of computing devices interacting with each other.

So far, the operation environment of the task assistance 10 according to some exemplary embodiments of the present disclosure has been described with reference to FIGS. 1 to 3. Hereinafter, a system/device 40b (i.e., a task assistant system/device) capable of implementing the above-described task assistant 10 will be described in detail with reference to FIGS. 4 to 16.

FIG. 4 is an illustrative block diagram illustrating a task assistant system 40 according to some exemplary embodiments of the present disclosure. Arrows illustrated in FIG. 4 and the like denote illustrative data flows.

As illustrated in FIG. 4, the task assistant system 40 may be configured to include a screen analyzer 41, an action determining module 42, a manipulation message generator 43, and a demo example generator 44. Only components related to exemplary embodiments of the present disclosure are illustrated in FIG. 4. Accordingly, one of ordinary skill in the art to which the present disclosure pertains may recognize that the task assistant system 40 may further include other general-purpose components (e.g., a processor, a memory, etc.) in addition to the components illustrated in FIG. 4. In addition, the components 41 to 44 of the task assistant system 40 illustrated in FIG. 4 represent functional elements functionally distinguished from each other, and a plurality of components may be implemented in a form in which they are integrated with each other in an actual physical environment or a specific component may be implemented in a form in which it is divided into a plurality of sub-components.

In some cases, the task assistant system 40 may be configured to further include a command interpreter (not illustrated) and a scheduler (not illustrated). The command interpreter (not illustrated) may interpret a user's command to distinguish a task description and a task-related condition from each other, and the scheduler (not illustrated) may execute scheduling for the target task (e.g., starting the execution of the target task when a start condition is satisfied, etc.) based on the task-related condition.

Hereinafter, each of the components 41 to 44 of the task assistant system 40 will be described.

The screen analyzer 41 is a module analyzing a screen of the task execution device 11 to generate a screen description. For example, the screen analyzer 41 may receive a screen image and analyze the screen image to generate a screen description (i.e., screen description information in a text format) including information of each of components (e.g., a text, a button, a list, an application, etc.) existing in the screen image. A specific method for analyzing the screen image may be any method. For example, the screen analyzer 41 may analyze the screen image using an image processing technique, an image analysis model (e.g., a component/object detection model, etc.), or the like, well known in the art or may analyze the screen image by another method. In some cases, the screen analyzer 41 may obtain information on components in the screen from an operating system. The screen analyzer 41 may analyze the screen again to generate a new screen description, whenever the screen of the task execution device 11 is updated by an action.

The component information may include, for example, an identifier (ID), a type, a position (coordinates), a size, a color, and component-specific information of the component, but the scope of the present disclosure is not limited thereto.

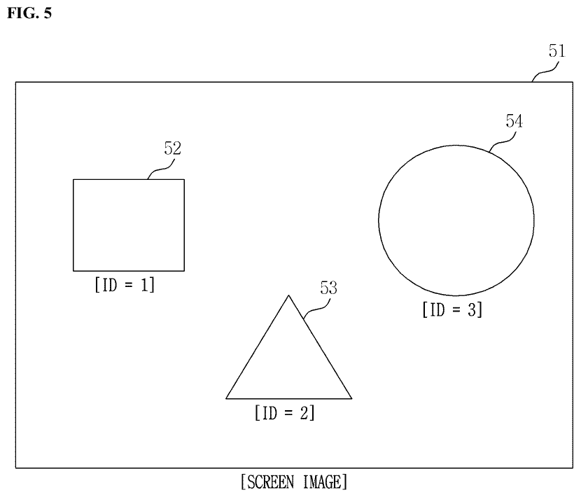

In some exemplary embodiments, as illustrated in FIG. 5, the screen analyzer 41 may analyze a screen image 51 to identify (detect) each of components 52 to 54 and assign a unique identifier (see ‘ID’) to each of the identified components. Alternatively, the screen analyzer 41 may obtain identifier information of the components 52 to 54 from the operating system. When the identifier information of the component (e.g., 52) is given to the generative model 12, the generative model 12 may generate an action (i.e., action description/information) of the form of ‘clicking a component-N (i.e., a component whose identifier is N)’ by utilizing the identifier of the component (e.g., 52), and as a result, an action associated with the target task may be more accurately determined.

A description will be provided with reference to FIG. 4 again.

The action determining module 42 is a module determining an action (i.e., a unit action) associated with the target task. For example, the action determining module 42 may repeatedly determine the action associated with the target task by configuring a prompt for action determination based on the task description (or the user command) for the target task, the screen description, and the like, and inputting the prompt to the generative model 12.

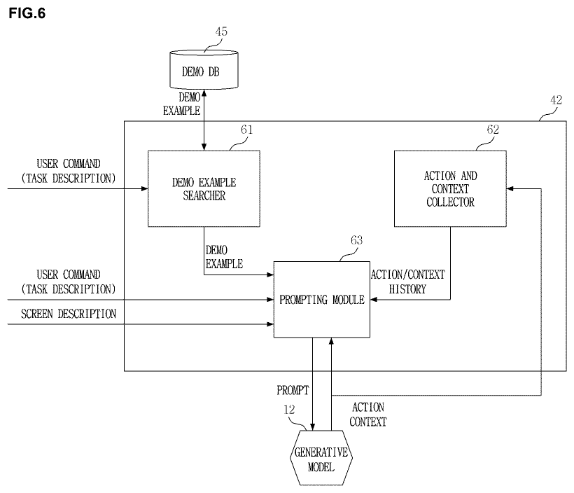

FIG. 6 is an illustrative block diagram for describing a configuration and an operation of an action determining module 42 according to some exemplary embodiments of the present disclosure.

As illustrated in FIG. 6, the action determining module 42 according to some exemplary embodiments may be configured to include a demo example searcher 61, an action and context collector (hereinafter abbreviated as a “collector”) 62, and a prompting module 63. However, the scope of the present disclosure is not limited thereto, and the action determining module 42 may be configured to further include another module or may be configured in a form in which some of the modules 61 to 63 illustrated in FIG. 6 are omitted. Hereinafter, each of the components 61 to 63 of the action determining module 42 will be described.

The demo example searcher 61 is a module searching a demo database (DB) 45 for one or more demo examples associated with the target task. For example, the demo example searcher 61 may search the demo DB 45 for a successful demo example and/or an unsuccessful demo example associated with the target task. A specific method in which the demo example searcher 61 searches the demo DB 45 may be changed depending on an implementation (construction) method of the demo DB 45.

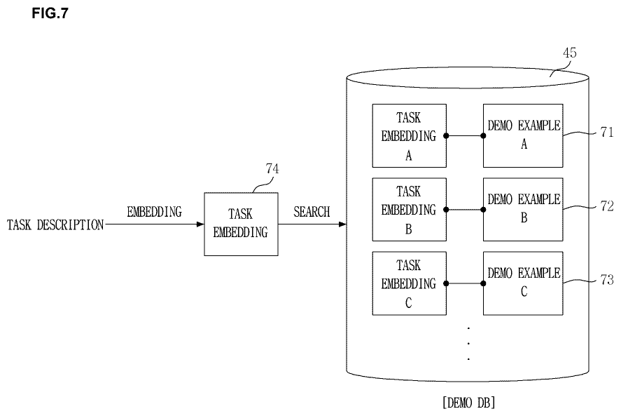

In some exemplary embodiments, the demo DB 45 may be implemented (constructed) based on a vector DB. Specifically, as illustrated in FIG. 7, various demo examples (e.g., 71 to 73) may be stored in the demo DB 45 in a state in which they are matched to task embeddings. Here, the task embedding may refer to an embedding vector generated by embedding the task description, and a specific embedding method may be any method (e.g., the task description may be embedded through a deep learning-based text embedding model such as Bidirectional Encoder Representations from Transformers (BERT)). In such a case, the demo example searcher 61 may generate a task embedding 74 by embedding the task description of the target task, and search the demo DB 45 based on similarity using the task embedding 74. For example, the demo example searcher 61 may search the demo DB 45 to obtain higher K demo examples (here, K is a natural number of 1 or more) having high similarity (e.g., cosine similarity, Euclidean distance-based similarity).

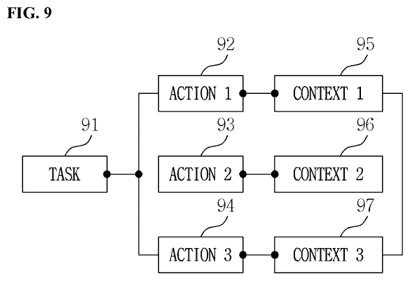

For a method for constructing the demo DB 45 as illustrated in FIG. 7, reference is made to a description of FIGS. 9 to 16.

A description will be provided with reference to FIG. 6 again.

The collector 62 is a module collecting actions (i.e., action descriptions/information) and contexts output from the generative model 12. For example, the collector 62 may generate an action history and a context history for the target task by storing an action and a context in a storage space whenever the action and the context are output from the generative model 12. The action history may be, for example, an action list including actions executed up to now (i.e., past actions), and the context history may be a context list including one or more contexts output up to now (i.e., past contexts). However, the scope of the present disclosure is not limited thereto.

The collector 62 may provide the action history and the context history to the prompting module 63. By doing so, the generative model 12 may determine the next action with reference to the past (previous) actions and contexts, and may be induced to more accurately determine the next action. The collector 62 may initialize the storage space (i.e., empty the storage space) whenever a new user command is received (i.e., whenever a new task is executed). For detailed contents on the context, reference is made to a description of FIG. 8 and Table 2.

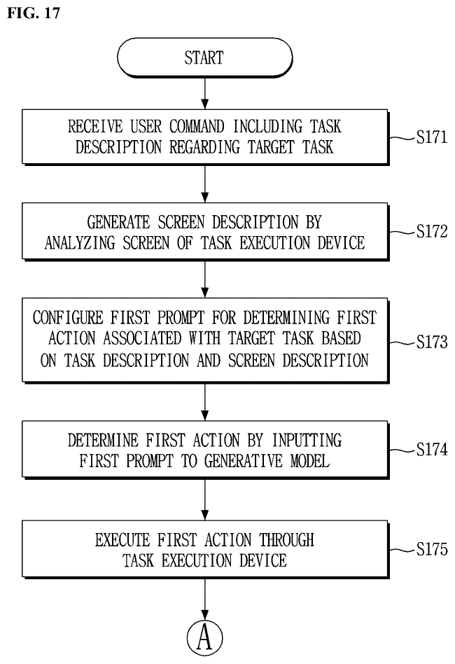

Next, the prompting module 63 is a module configuring (generating) a prompt used for action determination. The prompting module 63 may determine an action to be executed this time (i.e., obtain an action description/information from a response of the generative model 12 to the prompt) by inputting the prompt to the generative model 12. The prompting module 63 may repeatedly execute a process of configuring the prompt and determining the action until the processing of the target task is completed. For this, reference is made to a description of FIGS. 17 to 20.

For example, the prompting module 63 may configure the prompt based on the task description (or the user command), the screen description, the action history, the context history, the searched demo example, and the like. However, the scope of the present disclosure is not limited thereto, and the prompting module 63 may add some elements (information) to the prompt or may configure the prompt in a form in which at least some of the illustrated elements are omitted (e.g., some elements (information) may be added or removed in consideration of the maximum number of tokens set in the generative model 12.

Hereinafter, various elements of a prompt 81 will be described in more detail with reference to FIG. 8.

The prompting module 63 may configure the prompt 81 using at least some of elements 82 to 89-2 illustrated in FIG. 8.

A candidate action list 82 refers to a list of candidate actions that the generative model 12 may output (e.g., actions executable by the task execution device 11). The candidate action list 82 may serve to limit an action determined by the generative model 12 to a range of actions executable by the task execution device 11 by transferring range information of determinable actions to the generative model 12.

The candidate actions may refer to, for example, a type of actions executable by the task execution device 11 (e.g., mouse click, mouse scroll, keyboard input, etc.). The candidate action list 82 may be configured to include information/description of each candidate action, and the information of the candidate action may include, for example, a type, an output format, and other descriptions of the candidate action, but the scope of the present disclosure is not limited thereto. For specific examples of candidate actions and their output formats, reference is made to Table 1.

TABLE 1

| | |
|---|---|
| Candidate action | Mouse click: Coordinates (X, Y) |
| | Mouse scroll: (Scroll amount) |
| | Keyboard input: (Input text) |

It may be understood that the candidate action list 82 has fixed contents regardless of a change in task or screen. However, the scope of the present disclosure is not limited thereto.

Next, a demo example 83 refers to a demo example (e.g., a successful demo example and/or an unsuccessful demo example associated with the target task) searched in the demo DB 45. The demo example 83 may serve to further improve action determination accuracy of the generative model 12 by transferring reference information on the same/similar task to the generative model 12.

The number of demo examples 83 may be a preset fixed value or a value changed depending on a situation. For example, the number of demo examples 83 may be dynamically determined based on the current number of tokens of the prompt 81 and the maximum number of tokens set in the generative model 12. Such a technical idea may also be applied to determining the number of actions, the number of contexts, and the like.

Next, a user command 84 refers to a task description or an entire user command including the task description.

Next, an action history 85 refers to a list of past (previous) actions executed in order to process the target task (i.e., the user command 84). The action history 85 may serve to improve action determination accuracy of the generative model 12 by transferring information on the past (previous) actions to the generative model 12.

The action history 85 may include all actions executed up to now or include only some past actions (e.g., recent N actions (here, N is a natural number of 1 or more)).

Next, a context history 86 refers to a list of past (previous) contexts output by the generative model 12. The context history 86 may serve to improve consistency and accuracy of an action determination logic of the generative model 12 by transferring information considered by the generative model 12 when the past (previous) action is determined to the generative model 12 again (e.g., the generative model 12 determines an action with a consistent logic with reference to contexts output in the previous step.

Meanwhile, the number and a form of contexts included in the context history 86 (i.e., the past context list) may be variously designed.

For example, the context history 86 may include only one previous context. In such a case, a problem that a processing time of the generative model 12 increases due to a plurality of past (previous) contexts, a problem that the action determination accuracy of the generative model 12 is lowered because important information in the prompt 81 is concealed due to the past (previous) contexts, and the like, may be easily solved.

As another example, the context history 86 may include a predetermined number of (e.g., two or three) contexts. In this case, the predetermined number may be a preset fixed value or a value changed depending on a situation (see a description of the demo example 83).

As still another example, the context history 86 may include a predetermined number of summary contexts or include all summary contexts up to now. For the summary context, reference is made to a description of FIGS. 9 to 11.

As still another example, the context history 86 may include one previous context and a predetermined number of summary contexts.

As still another example, the context history 86 may be configured based on various combinations of the examples described above.

As described above, the context refers to a set of information that the generative model 12 considers to determine the action. For a specific example of detailed information of the context, reference is made to Table 2.

TABLE 2

| | |
|---|---|
| Context | Information/description of target task |
| | understood by generative model 12 |
| | Information/description of current screen |
| | understood by generative model 12 |
| | -> Information of the current screen may |
| | be configured based on information |
| | considered when a current action is |
| | determined. In this case, unnecessary |
| | screen information is removed, such |
| | that the generative model 12 may |
| | further concentrate on necessary screen |
| | information, and as a result, action |
| | determination accuracy may be further improved. |
| | Reason for determining current action |
| | Past (previous) actions and reason for |
| | determining each of past (previous) |
| | actions |
| | Plan for next action (e.g., plan for all |
| | actions to be executed in the future in |
| | order to process (solve) target task) |

Next, a screen description 87 refers to a description of a current screen. Here, the current screen may refer to, a for example, a screen updated by a previous action. The screen description 87 may serve to improve action determination accuracy of the generative model 12 by transferring information on the current screen to the generative model 12.

Next, a screen image 88 refers to an image of the current screen. When the generative model 12 has an image understanding function, the screen image 88 may also be included in the prompt 81.

Next, output instructions 89-1 and 89-2 include an instruction 89-1 for requesting the generative model 12 to output the context and an instruction 89-2 for requesting the generative mode 12 to output the action.

A context output instruction 89-1 is an instruction for requesting the generative model 12 to output a context for an action to be executed this time. For example, the context output instruction 89-1 may be composed of an instruction for requesting the generative model 12 to output information described in Table 2. The context may serve to induce the generative model 12 to more accurately determine the action.

Next, an action output instruction 89-2 may be composed of an instruction for requesting the generative model 12 to determine an action to be executed this time with reference to the candidate action list 82.

So far, the configuration and the operation of the action determining module 63 have been described in detail with reference to FIGS. 6 to 8.

Other components of the task assistant system 40 will be described with reference to FIG. 4 again.

The manipulation message generator 43 is a module generating a manipulation message corresponding to the action (i.e., a module converting the action into a manipulation message). The manipulation message generator 43 may transmit the manipulation message to the task execution device 11 to cause the corresponding action to be executed. The manipulation message generator 43 may be referred to as an ‘action executing module’ in some cases.

A specific method for generating the manipulation message may be any method. For example, the manipulation message generator 43 may convert the action into the manipulation message based on a predefined rule/algorithm. The rule/algorithm may be defined to convert the action into the manipulation message using, for example, action information/description and the screen description, but the scope of the present disclosure is not limited thereto. As another example, the manipulation message generator 43 may generate the manipulation message corresponding to the action using a specific generative model (e.g., the generative model 12 or another generative model). For example, the manipulation message generator 43 may generate the manipulation message by configuring a prompt including the action information, the screen description, an output instruction for the manipulation message, and the like, and inputting the prompt to the specific generative model.

Next, the demo example generator 44 is a module generating a demo example stored in the demo DB 45. The demo example generator 44 may generate successful demo examples and/or unsuccessful demo examples for various tasks. However, a specific method for generating the demo example may be changed depending on an exemplary embodiment.

In some exemplary embodiments, the demo example generator 44 may obtain an action list and a context list associated with a specific task and generate the demo example based on the action list and the context list. For example, the demo example generator 44 may obtain the action list (history) and the context list (history) from the collector 62 whenever the processing of the target task is completed, and may generate the demo example based on the action list (history) and the context list (history). This will be described in detail later with reference to FIGS. 9 to 11.

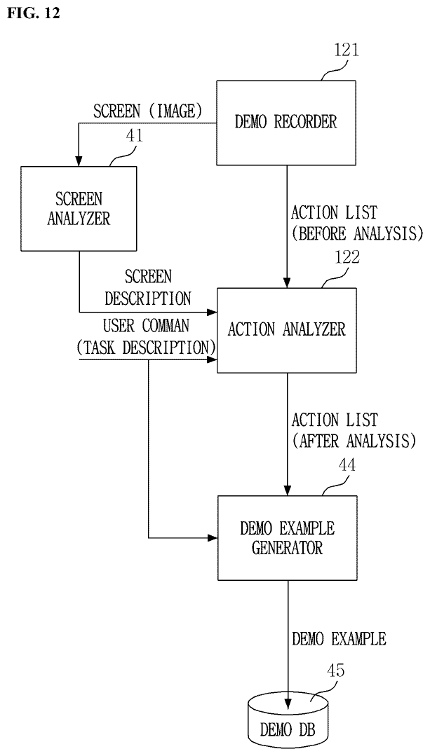

In some other exemplary embodiments, the demo example generator 44 may generate the demo example based on a task execution record of the user for a specific task. This will be described in detail later with reference to FIGS. 12 to 14.

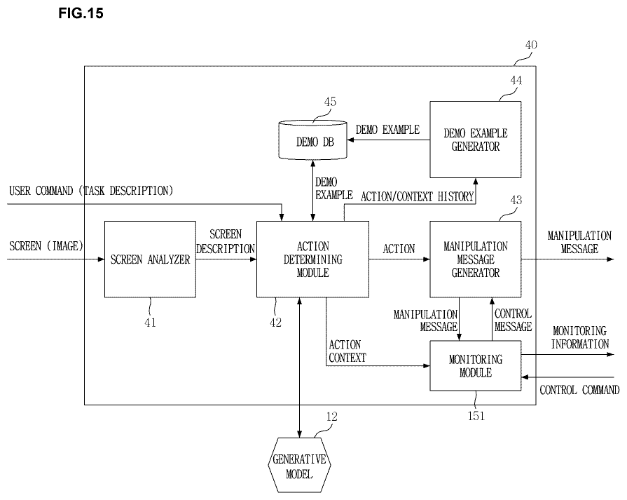

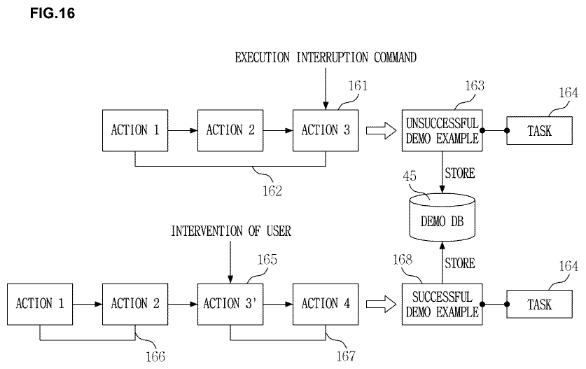

In some other exemplary embodiments, when the user interrupts execution of a specific task, the demo example generator 44 may generate an unsuccessful demo example for the specific task. This will be described with reference to FIGS. 15 and 16.

In some other exemplary embodiments, when processing of a task interrupted due to intervention of the user is completed, the demo example generator 44 may generate a successful demo example for the task. This will be described with reference to FIGS. 15 and 16.

In some other exemplary embodiments, the demo example may be generated based on various combinations of the above-described exemplary embodiments.

Next, the demo DB 45 is a storage storing demo examples for various tasks. For example, various demo examples may be stored in the demo DB 45 in a state in which they are matched to task embeddings (see a description of FIG. 7). The demo DB 45 may be an internal DB of the task assistant system 40 or a DB positioned outside the task assistant system 40. The demo DB 45 may be constructed by storing various demo examples, and for this, reference is made to a description of FIGS. 9 to 16.

Hereinafter, exemplary embodiments related to demo example generation will be described with reference to FIGS. 9 to 14.

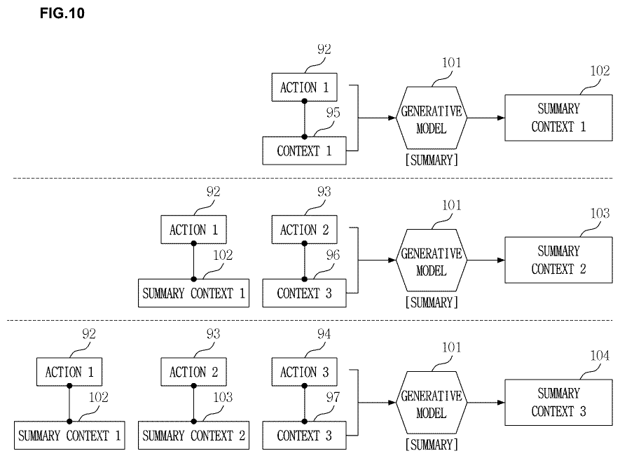

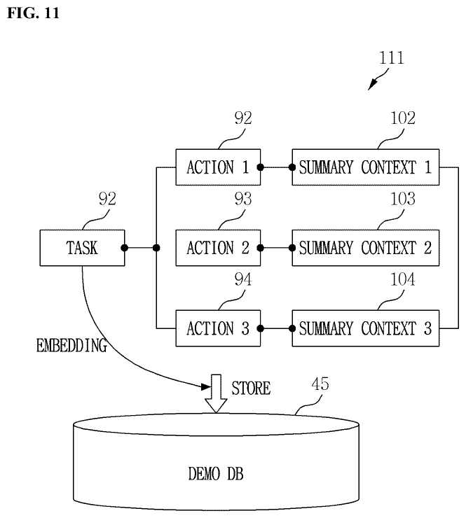

FIGS. 9 to 11 are illustrative diagrams for describing a method for generating a demo example according to some exemplary embodiments of the present disclosure. Specifically, FIG. 9 illustrates an action list 92 to 94 and a context list 95 to 97 of a specific task 91 obtained from the collector 62, and FIG. 10 illustrates a process of generating a summary context list 102 to 104. In addition, FIG. 11 illustrates a process of storing a demo example 111 based on the action list 92 to 94 and the summary context list 102 to 104 in the demo DB 45.

Assume that the demo example generator 44 has obtained an action list 92 to 94 and a context list 95 to 97 of a specific task 91 from the collector 62, as illustrated in FIG. 9. In such a case, the demo example generator 44 may generate the summary context list 102 to 104 (see FIG. 10) corresponding to the context list 95 to 97 based on obtained information, and generate a demo example (111 of FIG. 11) based on the summary context list. It may be understood that the context is summarized in order to simultaneously improve efficiency of information (e.g., efficiency of information is increased by removing duplicate information and unnecessary information in the context) and space efficiency of the demo DB 45.

Specifically, as illustrated in FIG. 10, the demo example generator 44 may generate a summary context 102 of a first action 92 from information of the first action 92 and its context (i.e., a first context) through a generative model 101. In other words, the demo example generator 44 may generate a first summary context 102 by inputting a prompt (e.g., that may further include a summary-related instruction) including the information of the first action 92 and its context 95 to the generative model 101. Here, the generative model 101 may be the same model as or a different model from the generative model 12 described above.

Next, the demo example generator 44 may generate a summary context 103 of a second action 93 by inputting the information of the first action 92 and its summary context 102 (i.e., the first summary context) and information of the second action 93 and its context 96 (i.e., a second context) to the generative model 101.

Similarly, the demo example generator 44 may generate a summary context 104 of a third action 94 by inputting the information of the first action 92 and its summary context 102 (i.e., the first summary context), the information of the second action 94 and its summary context 103 (i.e., a second summary context), and information of the third action 94 and its context 97 (i.e., a third context) to the generative model 101.

In a case of generating an N-th summary context, the demo example generator 44 may generate the N-th summary context by inputting information of first to N-th actions, first to N-1-th summary contexts, and an N-th context to the generative model 101.

Next, as illustrated in FIG. 11, the demo example generator 44 may store the demo example 111 including the action list 92 to 94 and the summary context list 102 to 104 in the demo DB 45. In this case, the demo example generator 44 may generate a task embedding by embedding a description of a specific task 92 and store the demo example 111 in a state in which the demo example 111 is matched to the task embedding. The demo example 111 may be a successful demo example or an unsuccessful demo example.

Meanwhile, in some cases, the demo example generator 44 may generate the demo example by not summarizing the contexts or summarizing only some contexts selected from the context list. For example, when an amount of the context list (i.e., an amount of data) is less than a reference value, the demo example generator 44 may generate the demo example using the action list and the context list as they are. Alternatively, the demo example generator 44 may generate the demo example by selecting an unimportant context from the context list and summarizing only the unimportant context. Here, the unimportant context may be, for example, a context in which an amount of duplicate text is a reference value or more, a context in which a length is less than a reference value, or the like, but the scope of the present disclosure is not limited thereto.

So far, the method for generating a demo example according to some exemplary embodiments of the present disclosure has been described with reference to FIGS. 9 to 11. Hereinafter, a method for generating a demo example according to some other exemplary embodiments of the present disclosure will be described with reference to FIGS. 12 to 14.

FIG. 12 illustrates overall processes of generating a demo example using a record of a demo executed by the user and related modules.

As illustrated in FIG. 12, in the present exemplary embodiments, the task assistant system 40 may be configured to further include a demo recorder 121 and an action analyzer 122.

The demo recorder 121 is a module recording a task execution process of the user. For example, the demo recorder 121 may be configured to record a list of actions (or a manipulation message list) executed by the user in order to solve a task and screen images (e.g., screen images before and after the actions, etc.), but the scope of the present disclosure is not limited thereto. The demo recorder 121 may be configured to output a task execution record including the action list and the screen image.

Next, the action analyzer 122 is a module analyzing the action list based on a screen description and a task description (or a user command). In this case, the screen description includes component information extracted from the screen image of the task execution record.

The action analyzer 122 may convert each of the actions included in the action list into an action regarding a component by analyzing the action list with reference to the screen description (e.g., the component information). For example, the action analyzer 122 may convert an action such as ‘clicking a position of coordinates (X1, Y1) with a mouse’ into an action such as ‘clicking No. 1 button with the mouse’ (here, No. 1 button exists at the coordinates (X1, Y1) of the screen image). When the demo recorder 121 is configured to output an action list of a component perspective, the action analyzer 122 may be omitted from the task assistant system 40.

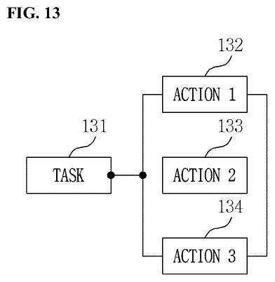

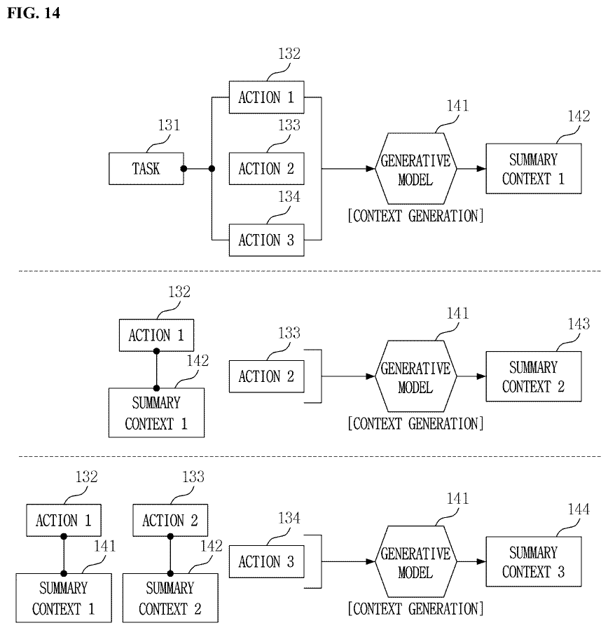

In such a case, the demo example generator 44 may generate a demo example based on the action list output from the action analyzer 122 (i.e., the action list converted into the component perspective). Specifically, the demo example generator 44 may generate a summary context list and/or a context list for the corresponding action list through a generative model 141 (see FIG. 14) and generate a demo example based on the summary context list and/or the context list. In order to provide convenience of understanding, a description will be provided in detail with reference to an example illustrated in FIGS. 13 and 14.

FIG. 13 illustrates an action list 132 to 134 output from the action analyzer 122, and FIG. 14 illustrates a process of generating a summary context list 142 to 144.

Assume that the demo example generator 44 has obtained an action list 132 to 134 of a specific task 131 from the action analyzer 122, as illustrated in FIG. 13. In such a case, the demo example generator 44 may generate a summary context list 142 to 144 from information obtained through the generative model 141 and store a demo example including the action list 132 to 134 and the summary context list 142 to 144 in the demo DB 45. The demo example may be a successful demo example or an unsuccessful demo example.

Specifically, as illustrated in FIG. 14, the demo example generator 44 may generate a summary context 142 of a first action 132 by inputting information (e.g., a task description, a user command, etc.) of the specific task 131 and the action list 132 to 134 to the generative model 141. That is, in a first step, the demo example generator 44 may induce the generative model 141 to accurately generate a first summary context 142 by providing sufficient information to the generative model 141. The generative model 141 may be the same model as or a different model from the generative model 12 or 101 described above.

Next, the demo example generator 44 may generate a summary context 143 of a second action 133 by inputting information of the first action 132 and its summary context 142 (i.e., the first summary context) and information of the second action 133 to the generative model 141.

Similarly, the demo example generator 44 may generate a summary context 144 of a third action 134 by inputting the information of the first action 132 and its summary context 142 (i.e., the first summary context), the information of the second action 133 and its summary context 143 (i.e., a second summary context), and information of the third action 134 to the generative model 141.

In a case of generating an N-th summary context, the demo example generator 44 may generate the N-th summary context by inputting information of first to N-th actions and first to N-1-th summary contexts to the generative model 141.

Next, the demo example generator 44 may store the demo example including the action list 132 to 134 and the summary context list 142 to 144 in the demo DB 45. For this, reference is made to the description of FIG. 11.

So far, exemplary embodiments of the method for generating a demo example have been described with reference to FIGS. 9 to 14. For other exemplary embodiments of a method for generating a demo example, reference is made to a description of FIGS. 15 and 16.

So far, the configuration and the operation of the task assistance system 40 according to some exemplary embodiments of the present disclosure have been described with reference to FIGS. 4 to 14. Hereinafter, a configuration and an operation of a task assistant system 40 according to some other exemplary embodiments of the present disclosure will be described with reference to FIG. 15. However, in order to clarify the present disclosure, a description of contents overlapping those of the previous exemplary embodiments will be omitted.

FIG. 15 is an illustrative block diagram illustrating a task assistant system 40 according to some other exemplary embodiments of the present disclosure.

As illustrated in FIG. 15, in the present exemplary embodiments, the task assistant system 40 may be configured to further include a monitoring module 151.

The monitoring module 151 is a module providing monitoring information on an action (or a target task) to the user. For example, the monitoring module 151 may provide various information such as an action, a context, and a manipulation message to the user before the action is executed in the task execution device 11. In some cases, the monitoring module 151 may also provide a simulation image regarding the execution of the target task to the user.

In addition, the monitoring module 151 may receive a control command (e.g., an execution command or an execution interruption command) for the action (or the target task) from the user and control the manipulation message generator 43 according to the control command. As an example, when an execution command for a first action is received from the user who has confirmed information on the first action, the monitoring module 151 may control the manipulation message generator 43 so that the first action is executed through the task execution device 11. As another example, when an execution interruption command for a second action (or a target task) is received from the user who has confirmed information on the second action, the monitoring module 151 may control the manipulation message generator 43 so that the second action is not executed through the task execution device 11. In this case, the task assistant system 40 may interrupt the execution of the target task or determine a third action for substituting for the second action through the generative model 12.

The functions as described above may be usefully utilized when the demo examples are not sufficiently accumulated in the demo DB 45, when the target task is an unfamiliar task, when the target task is a very important task, and when a specific action is an important action for the target task. That is, the functions as described above may be usefully utilized in the initial stage of configuration (construction) of the demo DB 45 or when the task should be carefully executed.

In some exemplary embodiments, the monitoring module 151 may automatically request intervention of the user based on importance of the action, importance of the target task, familiarity of the target task, and the like. For example, when importance of a specific action (or a target task) is a reference value or more or familiarity of the target task is lower than a reference value, the monitoring module 151 may automatically request a control command from the user and may control the manipulation message generator 43 according to the received control command. The importance of the action may be determined by the generative model 12 or calculated by another method. In addition, the importance of the target task may be determined by the generative model 12 or calculated by another method (e.g., importance information may be included in the user command). In addition, the familiarity of the target task may be determined by the generative model 12 or calculated by another method (e.g., the familiarity may be calculated as a value proportional to the number of associated demo examples searched in the demo DB 45 or familiarity information may be included in the user command).

In addition, in some exemplary embodiments, when an execution interruption command for a specific task is received from the user, the demo example generator 44 may generate an unsuccessful demo example for the specific task. For example, the demo example generator 44 may obtain an action list and its context list determined through the generative model 12 before a point in time when the execution interruption command is received, and generate an unsuccessful demo example based on the action list and the context list (e.g., the action list includes an action that has caused execution interruption). The generated unsuccessful demo example may be stored in the demo DB 45. As a more specific example, assume that an execution interruption command has been received from a user who has confirmed information on a third action 161 of a specific task 164, as illustrated in FIG. 16. In such a case, the demo example generator 44 may generate an unsuccessful demo example 163 for the specific task 164 based on an action list 162 and its context list (not illustrated). For a specific method for generating the demo example, reference is made to the description of FIGS. 9 to 11.

In addition, in some exemplary embodiments, when processing of the specific task whose execution is interrupted is completed by intervention of the user, the demo example generator 44 may generate a successful demo example for the specific task. For example, the demo example generator 44 may obtain a first action list executed before the point in time when the execution interruption command is received and a first context list thereof (e.g., the first action list does not include an action that has caused execution interruption). Then, the demo example generator 44 may obtain a second action list and a second context list thereof from a task execution record of the user for the specific task. Here, the task execution record may refer to an execution record for an unexecuted portion of the specific task (i.e., an execution record from an interrupted portion to the completion of the specific task). Then, the demo example generator 44 may generate a successful demo example based on the first action list, the first context list, the second action list, and the second context list. The generated successful demo example may be stored in the demo DB 45. As a more specific example, referring to FIG. 16 again, assume that the user has successfully completed the specific task 164 whose execution is interrupted by executing a third action 165 and an action after the third action 165 again. In such a case, the demo example generator 44 may generate a successful demo example 168 for the specific task 164 based on a first action list 166 executed before the execution interruption command, a second action list 167 executed by the user, and their context lists (not illustrated). For a specific method for generating the demo example, reference is made to the description of FIGS. 9 to 14.

So far, the configuration and the operation of the task assistant system 40 according to some other exemplary embodiments of the present disclosure and the method for generating a demo example have been described with reference to FIGS. 15 and 16. Hereinafter, a method for implementing a task assistant 10 according to some exemplary embodiments of the present disclosure will be described with reference to FIGS. 17 to 20.

Steps/operations of a method to be described later may be executed by processors of one or more computing devices/systems. Hereinafter, in order to provide convenience of understanding, a description will be provided assuming that the computing device/system is the task assistant system 40 described above. In this case, it may be understood that steps/operations of a method to be described later are physically executed by a processor of the task assistant system 40 and are logically executed by modules (e.g., 41 to 44 and 151) constituting the task assistant system 40.

In addition, hereinafter, in order to provide convenience of understanding, a description will be provided assuming that all steps/operations of a method to be described later are executed by the task assistant system 40. Accordingly, it may be understood that when a subject of a specific step/operation is omitted, the specific step/operation is executed in the task assistant system 40. However, in a real environment, some steps/operations of a method to be described later may also be executed in another computing device.

FIG. 17 is an illustrative flowchart illustrating portions of a method for implementing a task assistant according to some exemplary embodiments of the present disclosure. However, this is only an exemplary embodiment for achieving an object of the present disclosure, and some steps may be added or deleted, if necessary.

As illustrated in FIG. 17, the method according to exemplary embodiments may start in receiving a user command including a task description regarding a target task (S171). For example, the task assistant system 40 may receive the user command in a speech form and/or a text form.

In S172, a screen description is generated by analyzing a screen (i.e., a current screen) of the task execution device 11. For example, the task assistant system 40 may generate the screen description by analyzing a screen image of the task execution device 11 to identify a component existing in the screen image and extract information on the component. In this case, the task assistant system 40 may assign a unique identifier to the identified component. The task execution device 11 may be the same device/system as or a different device/system from the task assistant system 40. Alternatively, the task assistant system 40 may include the task execution device 11.

In S173 and S174, a first prompt for determining a first action associated with the target task is configured based on the task description and the screen description. In addition, the first action is determined by inputting the first prompt to the generative model 12.

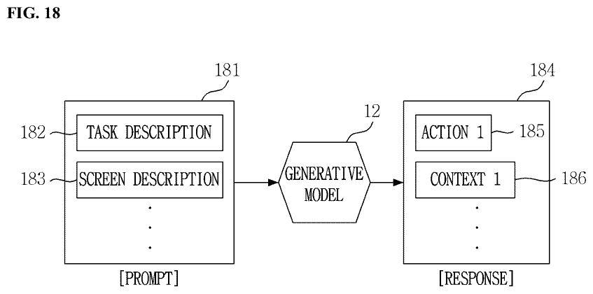

For example, as illustrated in FIG. 18, the task assistant system 40 may configure a prompt 181 so that a task description 182 (or a user command), a screen description 183, and output instructions for a first action 185 and a context 186 are included in the prompt 181, and may input the prompt 181 to the generative model 12. In some cases, the task assistant system 40 may further include other elements (e.g., the demo example 83, etc.) illustrated in FIG. 8 in the prompt 181. Next, the task assistant system 40 may obtain a description/information of the first action 185 and the context 186 from a response 184 of the generative model 12.

A description will be provided with reference to FIG. 17 again.

In S175, the first action is executed through the task execution device 11. For example, the task assistant system 40 may execute the first action by converting the first action into a corresponding manipulation message and transmitting the manipulation message to the task execution device 11.

In some cases, the task assistant system 40 may provide information related to the first action (e.g., information of the first action, a context of the first action, etc.) to a user and execute the first action in response to receiving an execution command of the user. For example, the task assistant system 40 may convert the first action into the corresponding manipulation message and transmit the manipulation message to the task execution device 11, in response to receiving the execution command.

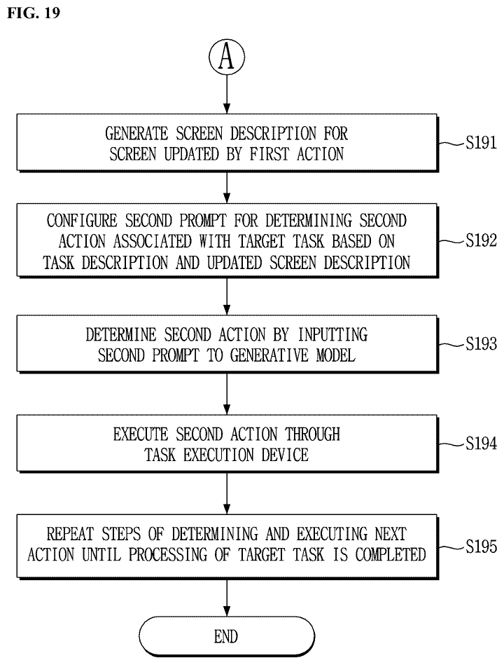

Hereinafter, steps after S175 will be described with reference to FIG. 19.

In S191, a screen description for a screen updated by the first action is generated.

In S192 and S193, a second prompt for determining a second action associated with the target task is configured based on the task description and the updated screen description. Here, the second action refers to a subsequent action of the first action. In addition, the second action is determined by inputting the second prompt to the generative model 12.

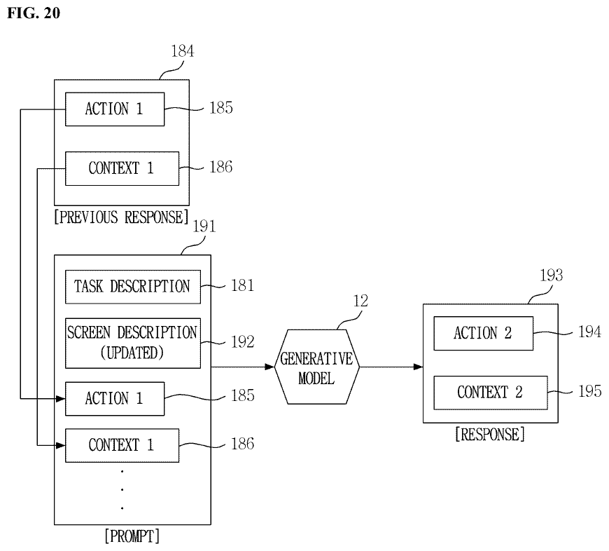

For example, as illustrated in FIG. 20, the task assistant system 40 may configure a prompt 191 for a second action 194 by including the information/description of the first action 185 and the context 186 to the prompt 191 again. The prompt 191 also includes the task description 181, the updated screen description 192, and output instructions for the second action 194, and a context 195. In some cases, the task assistant system 40 may further include other elements (e.g., the demo example 83, etc.) illustrated in FIG. 8 in the prompt 191. Next, the task assistant system 40 may obtain a description/information of the second action 194 and the context 195 from a response 193 of the generative model 12.

A description will be provided with reference to FIG. 19 again.

In S194, the second action is executed through the task execution device 11. For example, the task assistant system 40 may execute the second action by converting the second action into a corresponding manipulation message and transmitting the manipulation message to the task execution device 11.

In S195, steps (e.g., S191 to S194) of determining and executing the next action are repeatedly executed until the processing of the target task is completed.

So far, the method for implementing a task assistant according to some exemplary embodiments of the present disclosure has been described with reference to FIGS. 17 to 20. According to that described above, the action for the target task may be repeatedly determined using the generative model 12 that may understand a user's command, and the target task may be processed by executing the determined action. In such a case, unlike a robotic process automation (RPA) technology according to the related art, various tasks that are not defined in advance may be accurately processed. Moreover, complicated tasks executed through various applications on a computing device may be easily automated. Furthermore, the user does not need to directly manipulate the computing device, and thus, manipulation convenience of the computing device may be greatly improved.

In addition, by including an instruction for requesting the generative model 12 to output the context in the prompt for action determination, the generative model 12 may be induced to more accurately determine the action of the target task.

In addition, by including the context history in a prompt for determining the next action again, consistency and accuracy of an action determination logic of the generative model 12 may be further improved.

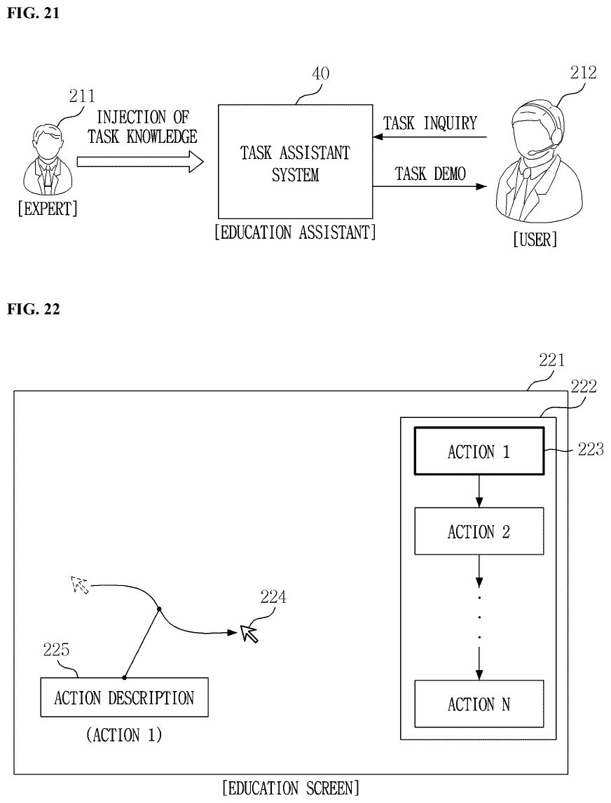

Hereinafter, a utilization example of the task assistant system 40 will be described with reference to FIGS. 21 and 22.

FIG. 21 is an illustrative diagram for describing a utilization example of the task assistant system 40 according to some exemplary embodiments of the present disclosure. FIG. 21 assumes that a task is executed in the task assistant system 40.

As illustrated in FIG. 21, the task assistant system 40 may be utilized to educate (guide) an unskilled user 212 (hereinafter abbreviated as a ‘user’) on a task execution method based on task knowledge of an expert 211 (i.e., a skilled user).

Specifically, various demo examples (e.g., demo examples for various tasks) generated from a task execution record of the expert 211 may be accumulated in the demo DB 45. Through such a process, the task knowledge of the expert 211 may be injected into the task assistant system 40, and the task assistant system 40 may operate like the expert 211 using such demo examples.

Next, the task assistant system 40 may provide various information on a specific task to the unskilled user 212 in response to an inquiry of the user 212 (e.g., a user command) about the specific task. For example, the task assistant system 40 may demonstrate an execution process of the specific task and show the execution process to the user 212. In this case, the task assistant system 40 may demonstrate the execution process of the specific task for each step (e.g., demonstrate the execution process in action units) or demonstrate the execution process of the specific task while interacting with the user 212 (e.g., demonstrate the next action when the user 212 clicks a button, demonstrate the previous action again, or repeatedly demonstrate a specific action). In addition, the task assistant system 40 may also provide detailed information on the specific task and actions to the user 212.

FIG. 22 illustrates an illustrative demonstration screen 221 (i.e., an education screen) for a task execution process.

As illustrated in FIG. 22, the task assistant system 40 may display an action list 222 of the task and various action information such as a description 225 of a current action 223 together on the screen 221 when demonstrating the task execution process. The action description 225 may include detailed information (e.g., mouse left click, mouse right click, mouse wheel use, specific key input on a keyboard, etc.) on the action 223 and a manipulation message, but is not limited thereto.

In some cases, the task assistant system 40 may highlight and display the current action 223 within the action list 222. By doing so, the task knowledge may be more effectively transferred to the user 212. For reference, such a control process may be executed at a request of the user.

In addition, in some cases, the task assistant system 40 may enlarge a size of a cursor 224 manipulated by the action 223 or adjust a movement speed of the cursor 224 (e.g., slowly move the curser).

So far, the utilization example of the task assistance system 40 according to some exemplary embodiments of the present disclosure has been described with reference to FIGS. 21 and 22. According to that described above, by accumulating the demo examples of the expert (i.e., the skilled user) in the demo DB 45, the task assistant system 40 that may educate (guide) the unskilled user on the task execution method may be easily implemented. In addition, the task knowledge of the expert may be easily and accurately transferred to various unskilled users through such a task assistant system 40.

Hereinafter, an illustrative computing device 230 (or computing system 230) capable of implementing the task assistant 10 will be described with reference to FIG. 23.

FIG. 23 is an illustrative hardware configuration diagram illustrating the computing system 230.

Referring to FIG. 23, the computing system 230 may include at least one processor 231, a system bus 233, a communication interface 234, a memory 232, which loads a computer program 236 executed by the processor 231, and a storage 235, which stores the computer program 236.

The processor 231 may control the overall operations of the components of the computing system 230. The processor 231 may perform computations for at least one application or program for executing operations/methods according to some embodiments of the present disclosure.

The memory 232 may store various data, commands, and/or information. The memory 232 may load the computer program 236 from the storage 235 to execute the operations/methods according to some embodiments of the present disclosure. The memory 232 may be implemented as a volatile memory such as a random access memory (RAM), but the present disclosure is not limited thereto.

The bus 233 may provide communication functionally among the components of the computing system 230. The communication interface 234 may support both wired and wireless Internet communication for the computing system 230. The storage 235 may temporarily store at least one computer program 236. The computer program 236 may include one or more instructions that, upon being loaded into the memory 232, direct the processor 231 to perform the operations/methods according to some embodiments of the present disclosure. In other words, by executing the loaded instructions, the processor 231 may perform the operations/methods according to some embodiments of the present disclosure.

In some embodiments, the computing system 230 may refer to a virtual machine implemented based on cloud technology. For example, the computing system 230 may be a virtual machine operating on one or more physical servers within a server farm. In this example, at least some of the components of the computing system 230, i.e., the processor 231, the memory 232, and the storage 235, may be implemented as virtual hardware, and the communication interface 234 may be implemented as a virtual networking element such as a virtual switch.

A computer program 236 may include instructions that cause the processor 231 to perform specific steps/operations/methods when loaded into the memory 232. That is, the processor 231 may perform specific steps/operations/methods by executing one or more instructions.

That is, the processor (231) may perform specific steps/operations/methods by executing one or more instructions.

For example, a computer program 236 may include instructions for an operation of receiving a user's command including a task description regarding a target task, an operation of generating a screen description by analyzing a screen of a task execution device, an operation of configuring a first prompt for determining a first action associated with the target task based on the task description and the screen description, an operation of determining the first action by inputting the first prompt to the generative model 12, and an operation of executing the first action through the task execution device 11.

As another example, the computer program 236 may include instructions for executing at least some of the steps/operations/methods described with reference to FIGS. 1 to 22.

In the case as illustrated, the task assistant system 40 according to some exemplary embodiments of the present disclosure may be implemented through the computing device 230. In other words, the task assistant 10 may be implemented on the computing device 230.

Meanwhile, in some exemplary embodiments, the computing device 230 illustrated in FIG. 23 may also refer to a virtual machine implemented based on a cloud technology. For example, the computing device 230 may be a virtual machine operating on one or more physical servers included in a server farm. In this case, at least some of a processor 231, a memory 232, and a storage 235 illustrated in FIG. 23 may be virtual hardware, and a communication interface 234 may also be implemented as a virtualized networking element such as a virtual switch.

So far, the illustrative computing device 230 capable of implementing the task assistant 10 according to some exemplary embodiments of the present disclosure has been described with reference to FIG. 23.

Various embodiments of the present disclosure and their effects have been described so far with reference to FIGS. 1 through 23. The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for implementing a task assistant, the method being executed by at least one processor, comprising:
receiving a user's command including a task description regarding a target task;
generating a screen description by analyzing a screen of a task execution device;
configuring a first prompt for determining a first action associated with the target task based on the task description and the screen description;
determining the first action by inputting the first prompt to a generative model; and
executing the first action through the task execution device.

2. The method of claim 1, wherein the generating of the screen description includes:
identifying one or more components existing on the screen; and
assigning an identifier to each of the one or more components, the screen description including information on the identifier.

3. The method of claim 1, wherein the first prompt includes an instruction for requesting the generative model to output a first context associated with the first action, and
the first context is a set of information that the generative model considers to determine the first action.

4. The method of claim 3, wherein the first context includes at least one of information of the target task understood by the generative model and information of the screen understood by the generative model.

5. The method of claim 3, wherein the first context includes a reason why the generative model has determined the first action.

6. The method of claim 3, wherein the first context includes plan information on an action to be executed after the first action.

7. The method of claim 3, further comprising:
configuring a second prompt for determining a second action associated with the target task based on the first context, the second action being a subsequent action of the first action; and
determining the second action by inputting the second prompt to the generative model.

8. The method of claim 7, wherein the second prompt is configured further based on the task description and a screen description for the screen updated by the first action.

9. The method of claim 1, wherein the first prompt includes a list of actions executed before the first action.

10. The method of claim 1, wherein the configuring of the first prompt includes:
obtaining a successful demo example associated with the target task by searching a demo database (DB); and
adding the successful demo example to the first prompt.

11. The method of claim 10, wherein each of a plurality of successful demo examples is stored in the demo DB in a state in which it is matched to a task embedding, and
the obtaining of the successful demo example includes:
generating an embedding of the target task by embedding the task description; and
searching the demo DB based on similarity between the embedding of the target task and the task embedding.

12. The method of claim 10, wherein a process of constructing the demo DB includes:
obtaining an action list and a context list associated with a specific task, the context list including a context associated with an action included in the action list, and the context being a set of information that the generative model considers to determine the action;
generating a summary context list from the action list and the context list through a specific generative model; and
storing a demo example of the specific task including the action list and the summary context list in the demo DB.

13. The method of claim 10, wherein a process of constructing the demo DB includes:
obtaining a task execution record of a specific user for a specific task, the task execution record including a first action list associated with the specific task and a screen image;
extracting information on a component existing in the screen image by analyzing the screen image;
converting the first action list into a second action list regarding the component with reference to the extracted information; and
storing a demo example of the specific task including the second action list in the demo DB.

14. The method of claim 10, wherein a process of constructing the demo DB includes:
obtaining an action list associated with a specific task;
generating any one of a context list and a summary context list of the action list from a description of the specific task and the action list through a specific generative model, a context included in the context list being a set of information that the generative model considers to determine an action included in the action list; and
storing a demo example of the specific task including the generated list and the action list in the demo DB.

15. The method of claim 1, wherein the configuring of the first prompt includes:
obtaining an unsuccessful demo example associated with the target task by searching a demo DB; and
adding the unsuccessful demo example to the first prompt.

16. The method of claim 15, wherein a process of constructing the demo DB includes:
obtaining an action list determined through the generative model before at a point in time when an execution interruption command for a specific task is received when the execution interruption command is received from a specific user;
generating the unsuccessful demo example based on the action list; and
storing the unsuccessful demo example of the specific task in the demo DB.

17. The method of claim 15, wherein a process of constructing the demo DB includes:
obtaining a first action list executed before at a point in time when an execution interruption command for a specific task is received when the execution interruption command is received from a specific user;
obtaining a second action list from a task execution record of the specific user for the specific task, the task execution record being an execution record for an unexecuted portion of the specific task;
generating a successful demo example based on the first action list and the second action list; and
storing the successful demo example of the specific task in the demo DB.

18. The method of claim 1, wherein the executing of the first action includes:
converting the first action into a manipulation message for an input device of the task execution device; and
transmitting the manipulation message to the task execution device.

19. A system for implementing a task assistant, comprising:
a screen analyzer generating a screen description by analyzing a screen of a task execution device;
an action determining module receiving a user's command including a task description regarding a target task, configuring a first prompt for determining a first action associated with the target task based on the screen description and the task description, and determining the first action by inputting the first prompt to a generative model; and
an action executing module executing the first action through the task execution device.

20. The system of claim 19, wherein the screen analyzer generates the screen description by identifying one or more components existing on the screen and assigning an identifier to each of the one or more components.

21. The system of claim 19, wherein the first prompt includes an instruction for requesting the generative model to output a first context associated with the first action, and
the first context is a set of information that the generative model considers to determine the first action.

22. The system of claim 19, wherein the first prompt includes a list of actions executed before the first action.

23. The system of claim 19, wherein the action determining module obtains a successful demo example associated with the target task by searching a demo DB, and configures the first prompt further based on the successful demo example.

24. The system of claim 19, wherein the action determining module obtains an unsuccessful demo example associated with the target task by searching the demo DB, and configures the first prompt further based on the unsuccessful demo example.

25. The system of claim 19, wherein the action executing module executes the first action by converting the first action into a manipulation message for an input device of the task execution device and transmitting the manipulation message to the task execution device.

26. A non-transitory computer-readable storage medium storing instructions,
wherein when the instructions are executed by one or more processors, the instructions cause the one or more processors to execute:
an operation of receiving a user's command including a task description regarding a target task;
an operation of generating a screen description by analyzing a screen of a task execution device;
an operation of configuring a first prompt for determining a first action associated with the target task based on the task description and the screen description;
an operation of determining the first action by inputting the first prompt to a generative model; and
an operation of executing the first action through the task execution device.
